(19) United States
(12) Patent Application Publication
(10) Pub. No.: US 2006/0217077 A1
(43) Pub. Date: Sep. 28, 2006

(54) Radio frequency device with null or quasi-null intermediate frequency minimizing interfering frequency modulation applied to an integrated local oscillator

(76) Inventor: Philippe Cathelin, Laval (FR)

Correspondence Address: JENKENS & GILCHRIST, PC, 1445 ROSS AVENUE, SUITE 3200, DALLAS, TX, 75202, US

(21) Appl. No.: 10/531,501

(22) PCT Filed: Oct. 8, 2003
(86) PCT No.: PCT/FR03/02956

§ 371 Date: Apr. 10, 2006

(30) Foreign Application Priority Data
Oct. 14, 2002 (FR) 02/12743

(51) Int. Cl. H04B 1/40

(52) U.S. Cl. 455/76

(57) ABSTRACT

A frequency transposition device is connected to a local main oscillator. The main oscillator is incorporated inside a main phase locked loop whereof the reference frequency is supplied by a voltage-controlled auxiliary oscillator, which is itself incorporated into an auxiliary phase locked loop. The reference frequency of the auxiliary phase locked loop is less than the frequency of the auxiliary oscillator for the main phase locked loop. The reference frequency of the main phase locked loop is less than the output frequency of the main oscillator, is greater than 10 times the frequency spacing of the channels reduced to the output frequency of the main oscillator, and is removed by a whole multiple of the send or receive frequency from at least the cut-off frequency of the main phase locked loop.

### PRIORITY CLAIM

The present application is a 35 U.S.C. 371 filing from PCT/FR2003/002956 which is an international filing from French Application for Patent No. 02 12743, filed Oct. 14, 2002, the disclosures of which are hereby incorporated by reference.

### BACKGROUND OF THE INVENTION

1. Technical Field of the Invention

The present invention relates to the synthesis of frequency and more particularly to that utilized in radio frequency devices, receivers or transmitters, of the type with a null or quasi-null intermediate frequency.

The invention applies advantageously, but not with limitation, to wireless communication systems, and more particularly to cellular mobile telephones.

2. Description of Related Art

In a terminal of a wireless communication system, such as for example a cellular mobile telephone, direct conversion, or transposition with null intermediate frequency, is an alternative to the superheterodyne architecture. Such conversion is particularly well adapted to allow architectural solutions which are very strongly integrated.

A direct-conversion receiver, or else a receiver with null intermediate frequency (receiver zero-IF), converts the useful signal band directly around the null frequency (base band) instead of converting it to an intermediate frequency of the order of a few hundred MHz.

A direct-conversion transmitter converts the base band of the signal directly around the radio frequency carrier frequency.

In this case, zero-IF radio frequency devices have difficulty in differentiating the useful signal if continuous parasite signals are present at entry. Also, in certain cases, it is preferred to utilize radio frequency devices with quasi-null (low IF) intermediate frequency, that is, whereof the intermediate frequency is not strictly null, rather it is low and in practice lower than one MHz.

Regardless, to generate a useful or quasi-null intermediate frequency it is necessary to use a local oscillator frequency, or transposition frequency, close to the radio frequency to either cause frequency transposition towards the radio frequency field of the signal to be transmitted (in the case of a transmitter), or to cause frequency transposition downwards, of the signal received (in the case of a receiver).

For the purposes of generating this transposition signal, a synthesizer having a frequency operating at a multiple frequency of the transposition frequency is generally used. And the transposition signal is then generated as it leaves a divider of suitable frequency.

The frequency synthesizer is generally obtained with a voltage-controlled oscillator (VCO) and a phase locked loop (PLL).

Due to imperfections in the chain of transmission or reception, parasite signals (harmonics or mixing products of useful signals) will exist and will be injected via parasite paths (magnetic coupling, capacitive coupling, and the like) in the voltage-controlled oscillator. The result is a frequency parasite modulation which is applied to the voltage-controlled oscillator. This mechanism is known to the expert as VCO PULLING.

More precisely, when a parasite signal at a phase-shifted Δf frequency relative to the output frequency of the local oscillator is applied to a voltage-controlled oscillator and operating at a given output frequency, this oscillator will be modulated in frequency with a frequency equal to Δf and an amplitude proportional to 1/Δf. Furthermore, in devices of null or quasi-null intermediate frequency, Δf is low, resulting in increased amplitude.

The result of this will be a perturbation in modulation at the output of the frequency transposition device or mixer, which is going to lead to more difficult decoding of information, and consequently to a more significant error rate.

The effects of these parasite perturbations are modified due to the local oscillator belonging to a phase locked loop.

More precisely, with respect to the phase locked loop, when the oscillator is modulated with a Δf frequency, the output of the charging pump of the phase locked loop is a sinusoidal wave having the Δf frequency. If Δf is greater than the cut-off frequency of the phase locked loop, the voltage control of the oscillator will not be affected. On the contrary, if Δf is low, that is, less than the cut-off frequency of the phase locked loop, the voltage control of the oscillator will act to reduce the amplitude of the modulation of the oscillator.

Furthermore, since the oscillator is connected to the phase locked loop, this results in a combination of two effects. Accordingly, at low frequency, the phase locked loop will correct perturbation. At high frequency, perturbation will be weak, due to the 1/Δf effect. On the contrary, in the vicinity of the cut-off frequency of the phase locked loop, there will be an increase in perturbation.

A natural solution to this problem would consist of creating a phase locked loop having an elevated cut-off frequency.

However, creating an increased cut-off frequency works against the stability of the loop. In effect, it is generally required, for reasons of stability, that this cut-off frequency is less than a tenth of the reference frequency of the loop.

Now, when the loop creates an entire division in frequency, the reference frequency provides spacing between the channels. Thus, for DCS application in which the channels are spaced every 200 kHz in the 1808 MHz-1880 MHz range, the reference frequency is in practice equal to 400 kHz for an oscillator supplying a frequency of 3.6 Ghz.

If the division made in the loop is not a whole division, then a higher reference frequency can be selected. However, using an improper divider is disadvantageous with respect to noise.

All things considered, in a DCS application a loop cut-off frequency of the order of 40 to 50 kHz maximum will be selected, which is largely insufficient to prevent the parasite problems of modulation mentioned above.

Other solutions can be envisaged to rectify these problems of parasite modulation.

Increased intermediate transposition frequencies, of the order of several MHz, can be used. However, this leads to an increase in current consumption of the receiver or transmitter.

An oscillator supplying an output frequency which is an increased multiple of the required transposition frequency can also be used. But, this will have an impact on current consumption and will necessitate use of particularly complex technology.

Finally, an attempt can be made to improve the insulation of the oscillator. But, this is particularly delicate to do on a chip, in particular when the chip also incorporates the frequency transposition means (or mixer).

There is accordingly a need in the art to provide a more satisfactory solution to the problems of frequency parasite modulation applied to the oscillator, and quite particularly when this oscillator and the mixer are integrated on the same chip.

### SUMMARY OF THE INVENTION

The invention proposes a radio frequency device of the type with null or quasi-null intermediate frequency, which is intended to receive or transmit a radio frequency signal whereof the transmission or reception frequency belongs to a frequency range subdivided into frequency channels.

According to a general characteristic of the invention the radio frequency device, consequently capable of being a radio frequency receiver or a radio frequency transmitter, a means of frequency transposition is connected to a so-called main local oscillator on an integrated circuit chip.

The main oscillator is incorporated within a main phase locked loop having a reference frequency supplied by a voltage-controlled auxiliary oscillator. The voltage controlled auxiliary oscillator is incorporated within an auxiliary phase locked loop having a reference frequency that is less than the frequency of the auxiliary oscillator.

Furthermore, the reference frequency of the main loop, that is, the frequency of the auxiliary oscillator, is less than the output frequency of the main oscillator. It is furthermore greater than ten times the frequency spacing of the channels reduced to the output frequency of the main oscillator. In addition, this reference frequency of the main loop is removed by a whole multiple of the send or receive frequency of at least the cut-off frequency of the main loop.

In other words, the invention proposes a frequency synthesizer with double phase locked loop.

A first oscillator, an auxiliary oscillator, allows all the desired characteristics for the transposition signal (channel selection, stability, phase noise, etc.) to be attained. This oscillator is controlled by the auxiliary loop. As this auxiliary oscillator oscillates at a frequency which does not correspond to any harmonic nor produce a mix of useful signals, it will not be perturbed.

A second oscillator, a main oscillator, oscillating for example at twice the transposition frequency, will be controlled by the main loop in taking the output frequency of the oscillator auxiliary as reference. As the reference frequency of the main loop is relatively high, the loop filter can have a relatively wide pass-band, of the order of several tens of MHz, having the following advantages:

all the interference will be reduced by the loop gain, and

the phase noise of the main oscillator will be directly given by the noise of the auxiliary oscillator.

As a consequence, it is not necessary to provide a high-performance oscillator, as a simple ring oscillator will be adequate.

When the auxiliary loop is intended for use with a whole divider, the reference frequency of the auxiliary loop is less than or equal to, preferably equal to, the frequency spacing of the channels reduced to the reference frequency of the main loop.

Furthermore, according to an embodiment of the invention, the reference frequency of the main loop is greater than the a twentieth of the output frequency of the main oscillator.

Therefore, in an embodiment in which the range of frequencies to which the send or receive frequency belongs is in the vicinity of 900 MHz or 1800 MHz (corresponding to the GSM or DCS standard), the reference frequency of the main loop can be taken as equal to 450 MHz, whereas the reference frequency of the auxiliary loop can be equal to 50 kHz. The output frequency of the main oscillator can then be equal to 3.6 Ghz.

The electronic integrated circuit chip, which already comprises the frequency transposition means as well as the local main oscillator, may also comprise the two phase locked loops.

Moreover, the device can be integrally produced on the electronic chip.

The invention also proposes a component of a wireless communications system, for example a cellular mobile telephone, incorporating a radio frequency device, such as defined above.

### BRIEF DESCRIPTION OF THE DRAWINGS

A more complete understanding of the method and apparatus of the present invention may be acquired by reference to the following Detailed Description when taken in conjunction with the accompanying Drawings wherein:

FIG. 1 diagrammatically illustrates a cellular mobile telephone incorporating in its transmission chain a frequency synthesizer according to the present invention;

FIG. 2 diagrammatically illustrates a cellular mobile telephone incorporating in its reception chain a frequency synthesizer according to the present invention; and

FIG. 3 illustrates in greater detail, though still diagrammatically, an embodiment of a synthesizer according to the present invention.

### DETAILED DESCRIPTION OF THE DRAWINGS

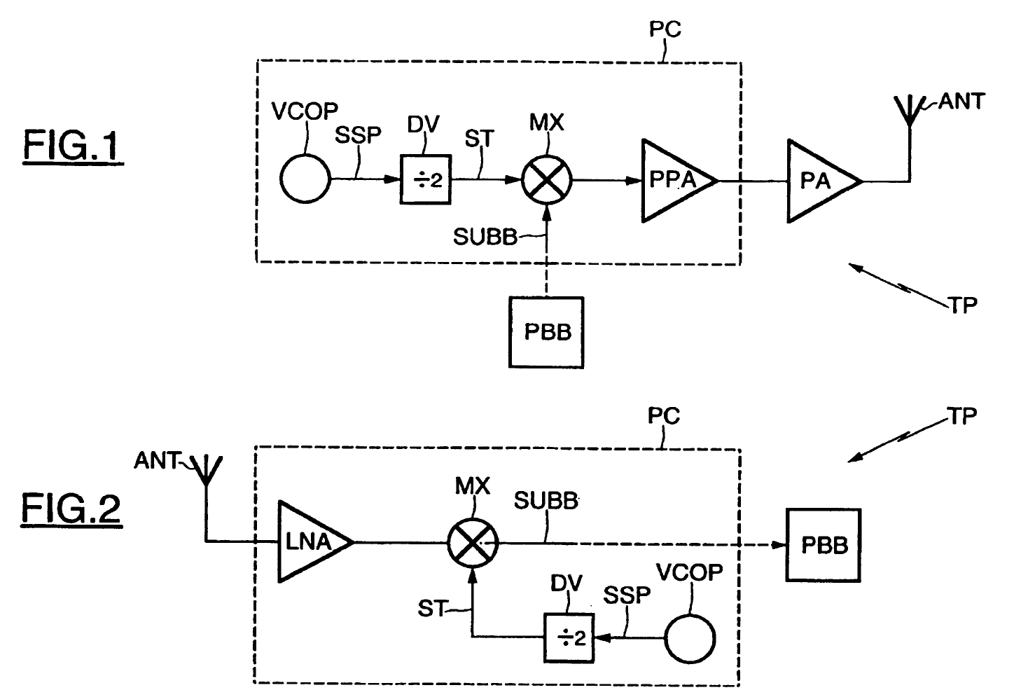

In FIG. 1, the reference TP designates a cellular mobile telephone intended in this example to function according to the DCS standard. In the DCS standard, the transmission frequency of the radio frequency signal or the reception frequency is part of a frequency range of between 1808 MHz and 1880 MHz, this frequency range being subdivided into frequency channels spaced at 200 kHz.

A voltage-controlled oscillator, to be designated hereinafter as “main oscillator,” bears the reference VCOP and emits an output signal SSP at an output frequency here equal to 3.6 Ghz. This main VCOP oscillator is followed by a frequency divider by two oscillators, designated as DV, supplying a transposition signal ST at a frequency of 1.8 Ghz.

A complex mixer MX (that is, processing the two channels I and Q, in phase and quadrature) receives, on the one hand, the transposition signal ST and, on the other hand, a useful signal in base band SUBB delivered by the processor in base band PBB of the telephone TP. At the mixer output the signal is modulated around the frequency of 1.8 MHz and is then transmitted by the antenna ANT of the telephone after passing into a preamplification stage PPA followed by a power amplification stage PA.

In the reception chain of the telephone TP, such as illustrated in FIG. 2, and connected to the output chain by a duplexer not shown here, the signal received by the antenna ANT is amplified in a low-noise amplifier LNA. Next, the signal is transposed in base band through the mixer MX by using the frequency transposition signal ST, likewise originating from a VCOP oscillator.

The useful signal in base band SUBB is then supplied after amplification and numerical analog conversion to the processor in base band PBB of the telephone TP.

One skilled in the art will note that the architecture described here for the chain of transmission or reception of the telephone TP is a so-called “zero IF” architecture, that is, with a null intermediate frequency.

Notwithstanding the foregoing, the invention also applies to radio frequency receivers or radio frequency transmitters of the type having a quasi-null intermediate frequency, that is, for example less than 1 MHz.

In high-integration solutions, as are currently recommended, the frequency transposition stage (or mixer) and the main oscillator VCOP are situated on the same electronic integrated circuit chip PC.

Due to imperfections in the send or receive chain, parasite signals (frequency harmonics or mixing products of useful signals) will appear and will be injected via parasite paths into the main oscillator, resulting in frequency parasite modulation applied to this main oscillator, and known to those skilled in the art by the name of “VCO PULLING.”

The present invention provides a solution to this problem, particularly critical when the main oscillator VCOP and the mixer MX are on the same integrated circuit chip PC.

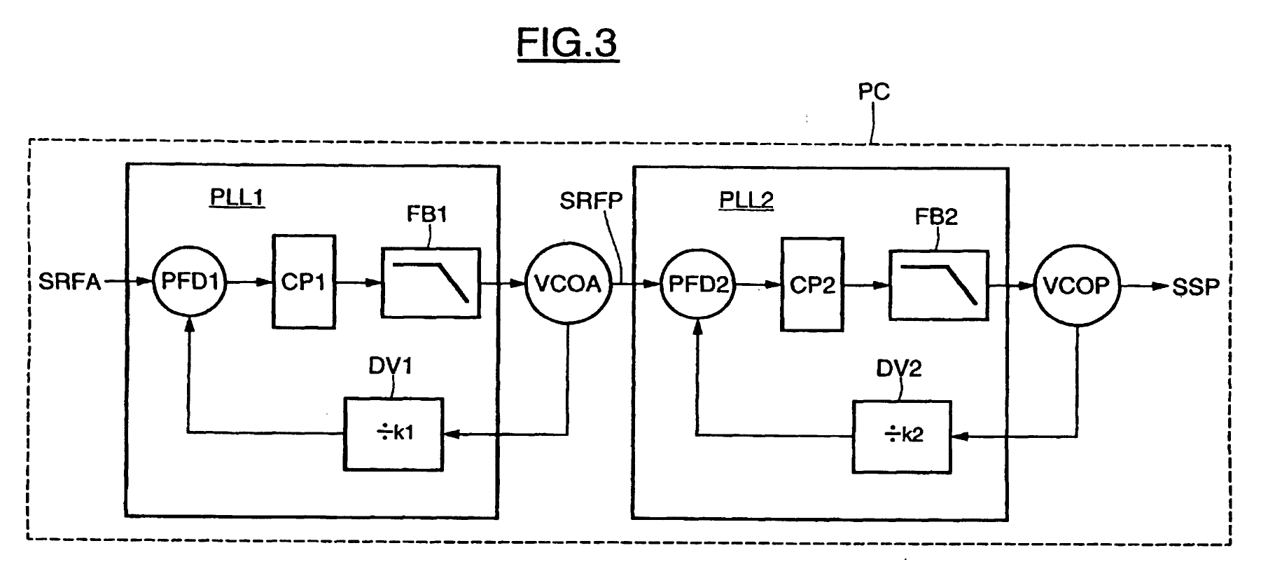

The present invention proposes a frequency synthesizer having two phase locked loops PLL1 and PLL2, such as shown in FIG. 3.

More precisely, the main oscillator VCOP is incorporated into a “main” phase locked loop, and designated as PLL2. This phase locked loop conventionally comprises a front detector PFD2 followed by a charging pump CP2 and a loop filter FB2. The output of the loop filter controls the voltage oscillator VCOP. The oscillator output VCOP supplies the signal SSP, and the output signal is also divided by a whole number k2 using a whole divisor DV2 before being compared to a reference signal SRFP in the front detector PFD2.

The reference signal SRFP is delivered by a another (auxiliary) voltage-controlled oscillator VCOA, itself incorporated into an auxiliary phase locked loop designated as PLL1. The architecture of this loop PLL1 is similar to that of the loop PLL2, with the difference that the whole division is this time carried out by divisor DV1 using a whole number k1.

Furthermore, the reference signal SRFA of the loop PLL1 is supplied by an external generator, for example a quartz oscillator.

In general, the frequency of the reference signal SRFP must be large to have a sufficiently wide band-pass of the loop PLL2, typically greater than 1 MHz, and in such a way that the loop PLL2 sharply reduces the effect of PULLING to which the oscillator VCOP is subject.

Furthermore, the frequency of the reference signal SRFP must be in a non-contaminated zone, that is, it must be removed by a whole multiple of the transmit or receive frequency, by at least the cut-off frequency of the main loop.

Accordingly, by way of example, for a telephone operating according to the DCS standard, a frequency of 450 MHz for the signal SRFP can be selected. The cut-off frequency of the loop can then be selected up to 1/10 of the frequency of the signal SRFP, here 45 MHz. In this case the choice will be guided by criteria peculiar to the application (noise, consumption, and the like).

Furthermore, since the frequency spacing of the channels is 200 kHz for an output receiving frequency in the vicinity of 1.8 GHz (corresponding to frequency spacing of 400 kHz for a frequency of the signal SSP equal to 3.6 GHz, or else to spacing of 50 kHz for the frequency of 450 MHz of the signal SRFP), a frequency of 50 kHz for the reference signal SRFA will be selected.

Thus, the reference frequency of the auxiliary loop is equal to the frequency spacing of the channels, reduced to the reference frequency of the main loop.

Since the oscillator VCOA oscillates at a frequency in a non-contaminated zone, that is, not corresponding to any harmonic nor produced from a mix of useful signals, it will not be perturbed.

Furthermore, although the main oscillator VCOP is subject to PULLING, the effect will be strongly reduced by the loop gain of the loop PLL2.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A radio frequency device of the type with null or quasinull intermediate frequency, intended to receive or transmit a radio frequency signal whereof the transmit or receive frequency is part of a frequency range subdivided into frequency channels, wherein it comprises on the same electronic chip frequency transposition means connected to a local main oscillator and in that a main oscillator is incorporated inside a main phase locked loop whereof a reference frequency is supplied by a voltage-controlled auxiliary oscillator , itself incorporated into an auxiliary phase locked loop whereof the reference frequency is less than the frequency of the auxiliary oscillator, in that the reference frequency of the main loop is less than the output frequency of the main oscillator, greater than 10 times the frequency spacing of the channels reduced to the output frequency of the main oscillator, and removed by a whole multiple of the transmit or receive frequency of at least the cut-off frequency of the main loop.

2. The device as claimed in claim 1, wherein auxiliary loop comprises a whole divider and in that the reference frequency of the auxiliary loop is less than or equal to, preferably equal to, the frequency spacing of the channels reduced to the reference frequency of the main loop.

3. The device as claimed in claim 1, wherein the reference frequency of the main loop is greater than a twentieth of the output frequency of the main oscillator.

4. The device as claimed in claim 1, wherein the range of frequencies to which the send or receive frequency belongs is in the vicinity of 900 MHz or 1800 MHz (corresponding to the GSM or DCS standard), the reference frequency of the main loop can be taken as equal to 450 MHz, whereas the reference frequency of the auxiliary loop can be equal to 50 kHz.

5. The device as claimed in claim 1 , wherein the electronic chip (PC) also comprises the two phase locked loops.

6. The device as claimed in claim 5, wherein it is integrally produced on said electronic chip.

7. A component of a wireless communications system, wherein it incorporates a device as claimed in claim 1.

8. The component as claimed in claim 7, wherein it forms a cellular mobile telephone.

9. A local oscillator, comprising:
a first phase lock loop receiving a first reference signal and incorporating a first voltage controlled oscillator which generates a second reference signal; and
a second phase lock loop receiving the second reference signal and incorporating a second voltage controlled oscillator which generates a local oscillator output signal.

10. The local oscillator of claim 9 wherein the second reference signal has a frequency that is less than a frequency of the local oscillator output signal, and the first reference signal has a frequency that is less than the second reference signal frequency.

11. The local oscillator of claim 10 wherein the second reference signal frequency is greater than N times the first reference signal.

12. The local oscillator of claim 11 wherein N equals ten.

13. The local oscillator of claim 11 wherein the first reference signal frequency is less than or substantially equal to a frequency spacing between communication frequency channels as reduced to the second reference signal frequency.

14. The local oscillator of claim 11 wherein the second reference signal frequency is in a non-contaminated zone with respect to the local oscillator output signal frequency.

15. The local oscillator of claim 14 wherein the non-contaminated zone is frequencies which are not harmonics or mixes of useful signals.

16. The local oscillator of claim 11 wherein the second reference signal frequency is greater than 1/M of the local oscillator output signal frequency.

17. The local oscillator of claim 16 wherein M is twenty.

18. The local oscillator of claim 11 wherein the second reference signal frequency is large enough to sharply reduce an effect of pulling as to the second voltage controlled oscillator.

19. A frequency synthesizer, comprising:
a double phase locked loop circuit wherein a first phase locked loop outputs a reference signal to a second phase locked loop which produces an output signal, the double phase locked loops operating a different frequencies with the reference signal output by the first phase locked loop having a frequency selected to reduce an effect of voltage controlled oscillator pulling within the second phase locked loop.

20. The frequency synthesizer of claim 19 wherein the reference signal frequency is not perturbed a frequency of use for the output signal.

21. The frequency synthesizer of claim 19 wherein the reference signal frequency is not a harmonic of the frequency of use of the output signal.

22. The frequency synthesizer of claim 19 wherein the reference signal frequency is a fraction of a frequency of the reference signal output.

23. The frequency synthesizer of claim 22 wherein the fraction is a twentieth.

24. The frequency synthesizer of claim 19 wherein the first phase lock loop receives an auxiliary reference signal having a frequency which is less than the reference signal frequency.

25. A radio frequency device of the type with a null or quasi-null intermediate frequency, intended to receive or transmit a radio frequency signal having a frequency that is part of a frequency range subdivided into frequency channels, comprising:
a frequency transposition mixer;
a local main oscillator connected to the mixer;
a main phase locked loop incorporating the main oscillator (VCOP) receiving a first reference frequency;
a voltage-controlled auxiliary oscillator (VCOA) supplying the first reference frequency; and
an auxiliary phase locked loop incorporating the voltage controlled auxiliary oscillator receiving a second reference frequency;
wherein the second reference frequency is less than the first reference frequency; and
wherein the first reference frequency is less than an output frequency of the local main oscillator, is greater than ten times a spacing of the frequency channels reduced to the output frequency of the main oscillator, and is removed by a whole multiple of the frequency for the radio frequency signal of at least the cut-off frequency of the main loop.

26. The device as claimed in claim 25, wherein the auxiliary phase locked loop comprises a whole divider and in that the second reference frequency of the auxiliary loop is less than or equal to the spacing of the frequency channels reduced to the first reference frequency.

27. The device as claimed in claim 25, wherein the first reference frequency of the main phase locked loop is greater than a twentieth of the output frequency of the local main oscillator.

28. The device as claimed in claim 25, wherein the range of frequencies to which the frequency of the main oscillator belongs is in the vicinity of 900 MHz or 1800 MHz, the first reference frequency is about 450 MHz, and the second reference frequency is about 50 kHz.

29. The device as is claim 25 wherein the device is fabricated as an integrated circuit chip.

30. The device as claimed in claim 29, wherein it is integrally produced on said electronic chip.
